(19) United States
(12) Patent Application Publication
(10) Pub. No.: US 2009/0130249 A1
(43) Pub. Date: May 21, 2009

(54) Methods to deliver low-inclusion ingredients into an animal feed ration

(75) Inventors: Chad Allen Conard, Fort Calhoun, NE (US); Shalis Winder, Omaha, NE (US)

Correspondence Address: CARGILL, INCORPORATED, LAW/24, 15407 MCGINTY ROAD WEST, WAYZATA, MN, 55391, US

(73) Assignee: CARGILL, INCORPORATED, Wayzata, MN (US)

(21) Appl. No.: 12/313,248

(22) Filed: Nov. 18, 2008

Related U.S. Application Data
(60) Provisional application No. 60/989,382, filed on Nov. 20, 2007.

(51) Int. Cl. A23K 1/16; A23K 1/00

(52) U.S. Cl. 426/2; 426/623; 426/72; 426/74; 426/648

(57) ABSTRACT

The present disclosure describes methods that maintain the substantially uniform distribution of low-inclusion ingredients in an animal feed ration. Such methods include combining a non-liquid admixture that includes the low-inclusion ingredients and a non-liquid carrier with a base animal feed to make an animal feed ration.

### CROSS-REFERENCE TO RELATED APPLICATIONS

This application claims the benefit of U.S. Provisional Application Ser. No. 60/989,382, filed Nov. 20, 2007, the disclosure of which is incorporated herein by reference

### TECHNICAL FIELD

This invention relates to animal feed, and more particularly to methods of delivering low-inclusion ingredients into an animal feed ration.

### BACKGROUND

It has long been a common practice to administer additives to livestock to supplement feed rations. Standard industry practice encourages the inclusion of various micro-ingredients into the feed ration to ensure optimal animal health and productivity. Feed additives can be used, for example, to help provide a balanced diet (e.g., vitamins and/or trace minerals), to protect the animals from disease and/or stress (e.g., antibiotics, probiotics) and/or to stimulate or control growth and behavior (e.g., hormones). Feed additives or supplements generally are administered to each animal or groups of animals on a regular basis in carefully controlled dosages, oftentimes very small dosages, to ensure optimal benefit. Such additives generally are considered to be low-inclusion ingredients. Low-inclusion ingredients are defined as those ingredients that constitute less than 1% to 2% of the feed ration.

Currently the beef and dairy industries use one of two methods to deliver low-inclusion ingredients (e.g., microingredients and/or macroingredients) into the animal feed ration. Feedlots or dairies that have a complete feed mill, with batch mixing capability, use a ‘micro-machine’ (see, for example, U.S. Pat. Nos. 3,437,075; 3,498,311; 3,670,923; 3,806,001; 3,822,056; and 4,733,971) that weighs each of the low-inclusion ingredients and uses a liquid (e.g., water) flush that is then pumped to the batch mixing system. This method of flushing typically increases the moisture content of the animal feed ration by about one percent.

Producers without access to a micro-machine generally procure their low inclusion ingredients as a pre-made pellet. The pre-made pellets are then added either to a feed mixer or directly to the animal feed ration. See, for example, Land O Lakes Finisher Plus® pellets (Catalog No. 1733800) or Land O Lakes Finisher Plus R250 T90® pellets (Catalog No. 1733820). See, also, the Choice® cattle feeding program offered by U.S. Feeds, which provides nine different pellet formulations (e.g., Recharge®; Regain 1®; Regain 5®; Regain 10®; 36 Beef®; Grow & Show®; Fiber Charge®; Gluten Balancer®; or Corn Distiller's Balancer®). There are several disadvantages to using pellets; their diverse composition requires complex storage, they are very sensitive to moisture (e.g., humidity), animals are able to ‘sort’ the less-palatable pellets from the feed ration, and pellet recipes are limited, which reduces a producer's ability to provide the ‘optimal’ formulation.

The present disclosure describes a method that maintains the substantially uniform distribution of low-inclusion ingredients in an animal feed ration without requiring the use of a liquid carrier or a micro-machine. A dosimeter could be used in the methods described herein, but these ‘micro-machines’ would not require the use of a liquid flush. This disclosure also eliminates the need for pre-made pellets.

### SUMMARY

The present disclosure describes novel methods that maintain the substantially uniform distribution of low-inclusion ingredients in an animal feed ration. Micro-ingredients can be added at the source of the primary ingredients such as, without limitation, to a wet or dry grain mill, to an oil refinery such as an expeller or solvent extract process facility, or to a distillery or any facility whose product or by-product is the primary ingredient of a high moisture animal feed ration.

Microingredients in any form (e.g., gas, liquid or solid) can be added to the flow of the primary feed ingredients in any of several manners such as, without limitation, electrically, hydraulically, pneumatically or manually such as flow controlling solenoids, metering pumps, lost weight dry matter hoppers or bins, time controlled augers or screws, complete micro-machines, or weigh scales or a volumetric metering devices.

This disclosure provides for methods that allow a manufacturer to offer the customer a fresh, safe, modified animal feed ration of added value, while allowing the manufacturer the opportunity to optimize their process. For example, shelf life is a primary concern for both the manufacturer and the customer. Many of the primary ingredients used in animal feeds have an inherently short shelf life, as do many low inclusion ingredients. Consumer resistance to the use of preservatives further contributes to the problem. The methods described herein can provide a manufacturer and their customer with an optimal animal feed ration whose shelf life is likewise optimal.

Many low inclusion ingredients are labeled by the federal government to control the exposure or dosage received by the material handlers, the animals themselves and, ultimately, the general public. The methods described herein make it easier for a manufacturer and/or their customer to comply with the intent of the labels and other regulatory instruments.

The methods described herein also can ensure that the dosage of low inclusion ingredients ingested by an animal is more consistent across feedings and is more accurate with respect to the labeling requirements. Providing an end user (e.g., a customer) with an animal feed ration containing only small quantities of the various low inclusion ingredients reduces an end users' risk of exposure to toxic levels of one or more low inclusion ingredients.

There are many variables that affect the elemental composition of the output of today's agricultural industries. For example, the efficacy of yeasts and enzymes to perform can be impacted by variations in temperature, pressure or other environmental parameters. The methods described herein allow and encourage a manufacturer of the primary ingredients to vary either or both the recipe and rate of inclusion of the various low inclusion ingredients. The result can be an animal feed ration having consistent nutritional value for a particular population of animals.

In one aspect, the invention provides for methods of making an animal feed ration. Such methods include providing a non-liquid admixture, wherein the non-liquid admixture comprises a non-liquid carrier and one or more low-inclusion ingredients; and mixing the non-liquid admixture with a base animal feed, thereby producing an animal feed ration. Such methods also can include providing the animal feed ration to an animal. Representative low-inclusion ingredients include ionophores, antibiotics, probiotics, vitamins, trace minerals, hormones, pheromones, nutraceuticals, pharmaceuticals, flavanoids, nutritive and non-nutritive supplements, and detoxicants. A representative non-liquid carrier is a high-moisture processed grain by-product.

In one embodiment, the non-liquid carrier is present in the animal feed ration at an amount of at least 15 weight percent or at an amount between 15 and 85 weight percent. A representative non-liquid carrier is corn gluten feed. For example, base animal feed includes ruminant feed, swine feed, poultry feed, equine feed, aquaculture feed, and wild game feed. In some instances, the low-inclusion ingredients are formulated for lactating or gestating cows or growing and finishing shoats, steers or heifers. It is a feature of the invention that the method is carried out in the absence of a liquid carrier.

In another aspect, the invention provides for methods for introducing one or more low-inclusion ingredients into an animal feed ration. Such methods include providing a non-liquid admixture, wherein the non-liquid admixture comprises a non-liquid carrier and the one or more low-inclusion ingredients; and mixing the non-liquid admixture with a base animal feed to produce an animal feed ration, thereby introducing the one or more low-inclusion ingredients into the animal feed ration. The methods disclosed herein maintain the low-inclusion ingredients in substantially uniform distribution in the feed ration.

In still another aspect, the invention provides for methods of introducing and maintaining the substantial uniformity of low-inclusion ingredients in a feed ration. Such methods include providing a non-liquid admixture, wherein the non-liquid admixture comprises a non-liquid carrier and the one or more low-inclusion ingredients; and mixing the non-liquid admixture with a base animal feed to produce an animal feed ration, thereby introducing and maintaining the substantial uniformity of the one or more low-inclusion ingredients in the animal feed ration.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the drawings and detailed description, and from the claims.

### DETAILED DESCRIPTION

The present disclosure describes materials and methods for making an animal feed ration. Specifically, the materials and methods disclosed herein allow for the uniform distribution of low-inclusion ingredients in a feed ration, and also allow for the substantially uniform distribution of low-inclusion ingredients to be maintained in the ration. Methods that ensure and maintain the substantially uniform distribution of low-inclusion ingredients are necessary to ensure that all the animals being fed the ration are receiving the correct or desired amount of each low-inclusion ingredient. The methods disclosed herein can make use of a micro-machine but do not require a liquid carrier (e.g., in the absence of essentially or substantially all liquid carrier such as water). In addition, methods are disclosed herein that allow for the uniform distribution of low-inclusion ingredients into an animal feed ration without requiring a feed operator to purchase a micro-machine or buy and store pre-made, pelletized low-inclusion ingredients.

Low-inclusion ingredients are ingredients that are added to an animal feed ration in low to very low levels (e.g., less than 1% to 2% (w/w or w/v)). Low-inclusion ingredients include, without limitation, ionophores, antibiotics (e.g., chlortetracycline (CTC), oxytetracycline, bacitrain, tylosin, aureomycin), probiotics and yeast cultures, vitamins, trace minerals (e.g., Cu, Zn, Fe, Se), macrominerals (e.g., Ca, P, Mg, K), coccidiostats (e.g., amprollium, decoquinate, lasalocid, monensin), and hormones (e.g., growth hormones or hormones that inhibit estrus and/or ovulation such as melengestrol acetate). Low inclusion ingredients also can include pheromones, nutraceuticals, pharmaceuticals, flavanoids, nutritive and non-nutritive supplements (e.g., minerals in a specific form), and detoxicants. Some commercially available low-inclusion ingredients are sold under the trade names Rumensin®, Bovatec®, Deccox®, Tylan®, Optaflexx®, and MGA®. See, also, for example, X-tra Factors (Pratt, Kans. and Ephrate, Pa.). Low-inclusion ingredients can be, for example, in granular, powdered or liquid form or microencapsulated.

Regarding the use of probiotics in animal feed, see, for example, Gedek, 1987 (November), “Probiotics in Animal Feeding—Effects on Performance and Animal Health”, Feed Magazine; and Klaenhammer, 1982 “Microbiological Considerations in Selection and Preparation of Lactobacillus Strains for Use as Dietary Adjuncts”, J. Dairy Sci., 65:1339-1349. See, also, COBACTIN® (Biotechniques Laboratories, Inc., Redmond, Wash.).

An animal feed ration can be produced that contains a particular combination of low-inclusion ingredients that, according to the methods disclosed herein, are distributed substantially uniformly throughout the feed ration. An “animal feed ration” as used herein refers to the combination of a base animal feed and a non-liquid admixture containing particular low-inclusion ingredients. A “base animal feed” as used herein generally refers to a ration that contains any of the various cereal grains, their by-products, and other sources of primary nutrition (fat, fiber, and protein) such as, but not limited to, barley, blood meal, bone meal, Brewer's grain, corn grain, corn gluten meal, corn gluten feed, cottonseed (e.g., whole or meal), distiller's grain, fish meal, hominy, feather meal, molasses, peanut skins, soybeans (e.g., whole or meal), tallow, and wheat (e.g., whole, bran or middlings). An animal feed ration as used herein can be formulated for pigs, cattle, horses, poultry, various domestic pets, aquatic animals, and any other animal (e.g., a livestock animal), and is usually complimented by the admixture of the various low inclusion ingredients mentioned herein. This allows the animal(s) caretaker with the ability to provide an optimal animal feed ration, thereby minimizing threats to the animal's well-being. These threats include, but are not limited to those caused by disease, parasites, stress from relocation, pregnancy, environmental factors and sub-optimal nutrition.

The present disclosure describes methods of introducing low-inclusion ingredients into a base animal feed such that the resulting feed ration produced possesses a substantially uniform distribution of low-inclusion ingredients throughout. The methods disclosed herein provide means for maintaining the substantially uniform distribution of low-inclusion ingredients in the animal feed ration without the use of extremely large and expensive machines used, for example, by the larger feed manufactures and the biggest feed lots. The methods disclosed herein for making an optimal animal feed ration utilize a non-liquid admixture to introduce and disperse the low-inclusion ingredients throughout a base animal feed and, as such, they do not require the use of any types of liquid carrier or flush.

As used herein, a “non-liquid admixture” refers to one or more low-inclusion ingredients in combination with a non-liquid carrier. A “non-liquid carrier” as used herein refers to any of a number of high-moisture processed grain by-products. Such high-moisture processed grain by-products result from the processing of a number of different grains such as corn, wheat, and milo. Examples of high-moisture processed grain by-products include, without limitation, gluten, non-grain feed ingredients (e.g., molasses, beet pulp and other crop residues), and wet distiller's grain. One example of a suitable high-moisture processed grain by-product is a commercial product marketed under the trade name SweetBran® (Cargill, Inc.; Minnetonka, Minn.).

The low-inclusion ingredients and the non-liquid carrier can be combined to generate a non-liquid admixture using an auger, an airlock or other mechanical conveying means. Similarly, a non-liquid admixture containing a particular combination of low-inclusion ingredients and the non-liquid carrier can be combined with an appropriate base animal feed using, for example, an auger, a ribbon, a paddle or other mixing technology. Either or both combining steps can be done by a commercial manufacture of animal feed and provided to a rancher or a feedlot operator already mixed. It is an advantageous feature of the invention, however, that either or both of the combining steps can be done on-site by a farmer, rancher or feedlot operator without a large investment in machinery or storage space.

It is understood by those of skill in this art that many currently available feed rations contain at least one high-moisture processed grain by-product. Thus, one of the advantages of a feed ration made by the methods disclosed herein is that the end-product animal feed ration does not differ substantially in composition than that of many of the currently available feed rations. As would be apparent to those of skill in the art, the amount of one or more high-moisture processed grain by-products in a base animal feed that is to be used in the methods disclosed herein can be reduced appropriately so as to account for the amount of high-moisture processed grain by-product present in the non-liquid admixture.

The use of a non-liquid carrier that includes a high-moisture processed grain by-product allows for the low-inclusion ingredients to be mixed thoroughly and uniformly throughout the base animal feed. More importantly, the use of a non-liquid carrier to introduce the low-inclusion ingredients as described herein serves to maintain the substantially uniform distribution of the low-inclusion ingredients in the overall feed ration and prevent the low-inclusion ingredients from becoming separated from the base feed.

There are numerous advantages provided by the present invention. For example, the present methods do not require large expensive equipment to generate an optimized animal feed ration, the present methods do not require the use of a liquid carrier to introduce the low-inclusion ingredients, and the present methods do not require the use of extensive storage facilities (e.g., for pellets). Use of these methods also ensures that the low-inclusion ingredients are maintained in substantially uniform distribution throughout the feed ration. In addition, there is little to no difference in palatability between a feed ration made by the present methods and currently available feed rations because the components are not significantly different, and feed rations made by the present methods can cost the same or less than feed rations made using existing methods due to, for example, a reduction in the storage and transportation costs that the present animal feed rations and methods of making such animal feed rations require.

Although the present methods can be used by anyone in the commercial livestock industry, the present methods allow a rancher or feedlot operator to be able to prepare, on demand, a particular feed ration to meet the needs of a particular population of animals. The present methods provide much-needed flexibility to smaller operators, who are no longer required to purchase large expensive micro-machines or store different pre-mixed combinations (e.g., pellets). For those operators who do have access to a micro-machine or something similar, the present method allows for production of an optimized animal feed ration in the absence of a liquid carrier.

In accordance with the present invention, conventional animal science technology within the skill of the art may be employed. Such technology is explained fully in the literature. The invention will be further described in the following examples, which do not limit the scope of the invention described in the claims.

### EXAMPLES

### Example 1

### Recipes for Feed Rations

Table 1 shows the ingredients in a starter ration, while Table 2 shows the ingredients in a Finisher Ration.

TABLE 1
Formulation of Starter Ration

| | | | Sweet- | | |
|---|---|---|---|---|---|
| Corn | ILS18 | Hay | Bran ® | Total | |
| 1910 | 760 | 1170 | 1360 | 5200 | |
| 0.85 | — | 0.85 | 0.6 | 0.66 | Non-liquid |
| | | | | | matter |
| | | | | | excluding |
| | | | | | supplement |
| 47.3% | | 29.0% | 23.8% | 100.0% | Mass |
| | | | | | percentage |
| | | | | | (dry basis) |
| | | | | | excluding |
| | | | | | supplement |

TABLE 2
Formulation of Finisher Ration

| | HM | Supple- | | | |
|---|---|---|---|---|---|
| Corn | corn | ment | Hay | SweetBran ® | Total |
| 2800 | 1870 | 340 | 480 | 4510 | 10,000 |
| 0.85 | 0.7 | | 0.85 | 0.6 | 0.68 |
| 35.0% | 19.2% | | 39.8% | 39.8% | 100.0% |

TABLE 3
Box Sizes for 20,000 Lb Batch (3 Loads)

| | | Conveying | Bulk | | |
|---|---|---|---|---|---|
| | Capacity | Rate | Density | Volume | Capacity |
| | (lbs) | (tons/hr) | (lbs/ft³) | (ft³) | (tons) |
| Corn hopper | 6160 | 56.0 | 32 | 510.125 | 8.16^{a} |
| HM Corn | 12,342 | 37.4 | 35 | 352.6 | 6.17 |
| box | | | | | |
| Hay box | 3861 | 23.4 | 10 | 386.1 | 1.93^{b} |
| SweetBran | 29,766 | 90.2 | 50 | 595.3 | 14.88 |
| box | | | | | |

207.0 tons/hr rate to truck; 183.6 mixing rate
^{a}need to size feed conveyor to fill hopper within 5 mins of batch completion;
^{b}worse-case 3 starter rations in a row

### Example 2

### Microingredients

Tables 4 and 5 show representative combinations of low-inclusion ingredients that can be added to an animal ration.

TABLE 4

| | | bulk | | | Min inclusion | | Max inclusion | | | Weekly usage | |
|---|---|---|---|---|---|---|---|---|---|---|---|
| | | density | % of | | in complete | | in complete | | typical package | per 10,000 | per |
| Ingredient | Form | (lb/ft3) | batch | lbs/hd/day | ration* | | ration* | | size | head (lbs) | batch |
| Rumensin | granular | 41 | | 0.0021 | 45 | g | 150 | g | 50 lbs bag | 315 | 2.63 |
| Tylan | micor-beads | 39.8 | | 0.00011 | 10 | g | 10 | g | 50 lbs bag | 175 | 1.75 |
| Optaflexx | granular | 16.3 | | 0.0036 | 0.18 | lbs | 0.54 | lbs | 25 lbs bag | 253 | 2.53 |
| Vit ADE | powder/liquid | 40 | | | 1 | lb | 8 | lbs | 25 lbs bag/2.5 gal | 0 | — |
| MGA | powder/liquid | | | | | | | | 25 lbs bag/2.5 gal | 112 | 1.12 |
| Vit E | liquid | | | 0.00043 | 10 | g | 35 | g | drum or tote | 30 | — |
| Trace Mineral | powder | 75 | | | 1 | lb | 15 | lbs | 50 lbs bag | | 7.00 |
| pak | | | | | | | | | | | |
| CTC/AS700 | powder | | | | | | | | 50 lbs bag | | — |
| Microbial pak | powder | | | | | | | | | 550 | 5.50 |

TABLE 5

| | Conc | g/t | | | | | |
|---|---|---|---|---|---|---|---|
| Ingredient | g/lb | ration | lb/t | 80 | head | | 1,000 |
| Rumensin | 80 | 30 | 0.38 | 30 | mg/hd | | 360 |
| Tylan | 40 | 10 | 0.25 | | g/day | | 360 |
| Optaflexx | 45.4 | 16.4 | 0.36 | | lb/d | | 4.5 |
| Vit ADE | | | | | lb/wk | | 31.5 |
| MGA | 0.2 | 0.032 | 0.16 | | 10,000 | day | 45 |
| Vit E | | | | | 10,000 | wk | 315 |
| Trace Mineral | | | 1 | | 100,000 | day | 450 |
| pak | | | | | | | |
| X-tra factors | | | 0.79 | 0.63 | 100,000 | wk | 3150 |
| Microbial pak | | | 1.15 | 0.60 | | | |

### Example 3

### System for Making a Feed Ration

A system for making a feed ration as described herein generally includes a ground corn tank, a SweetBran® box, a high-moisture corn (HMC) box, and a hay box.

A ground corn tank can have a capacity of 16,300 lbs of rolled corn, which allows dry rolled corn (DRC) to replace HMC during the majority of the year (9 months expected), and a minimum usable volume of, for example, 510 cubic feet. The tank can be of a standard size (e.g., 6′ diameter, 14′ straight sides, 60° cone) with a gravity discharge rate of 75 tons per hour. The tank can have a slide gate outlet, and be equipped with load cells. The tank also may have one or more indicators located, for example, on top of the tank to stop the filling system or at the middle or bottom of the tank to signal initiation of filling. A ground corn tank can be made from 304 stainless steel, galvanized steel, aluminum, or another acceptable material.

A SweetBran® box can have a capacity of 15 tons (e.g., 40-50 lbs/ft³) and be of a standard size (e.g., 12′ long, 5′ tall on short end, 7′-6″ tall on high end, 8′ wide (˜375 ft³ volume)). A SweetBran® box can have a discharge rate of 90 tons per hour, and can use an 8′ long, 18″ screw conveyor having a variable pitch with the outlet on the shallow end of the box. An example of an incline is 3′ of incline over a 12′ length. Instead of or in addition to a screw conveyor, a SweetBran® box can have a pin agitator having, for example, 5.5° diameter pins. A SweetBran® box can be made from 316 stainless steel, with all surfaces that contact product made from 304 stainless steel.

A HMC box can have a capacity for 7 tons of HMC, and be of a standard size (e.g., 12′ long, 5′ tall on short end, 7′-6″ tall on high end, 8′ wide (˜350 ft³ volume)). A HMC box can have a 30 ton per hour discharge rate, and use either an 8′ long, 18″ screw conveyor having variable pitch with a center discharge or a pin agitator having; for example, 5.5° diameter pins. A HMC box can be fabricated from 316 stainless steel, with all surfaces that contact the feed product made from 304 stainless steel.

A hay box can have the same basic design as a HMC box, with a capacity of 2 tons of ground hay. A hay box can be of a standard size (e.g., 12′ long, 5′ tall on short end, 7′-6″ tall on high end, 8′ wide (˜350 ft³ volume)). A hay box can have a discharge rate of 20 tons per hour using, for example, either an 8′ long, 18″ screw conveyor having variable pitch with a center discharge or a pin agitator having, for example, 5.5° diameter pins. A hay box can be made from 316 stainless steel, with all surfaces that contact product made from 304 stainless steel.

### Example 4

### Making a Feed Ration

One embodiment of making an animal feed ration as disclosed herein is as follows. A feed wagon operator first requests a ration and selects standard or non-standard batch size. Based on the total weight, the operator calculates the total time required for SweetBran® addition assuming a rate of 90 ton/hr. The mass addition rate required for the micro-ingredients also is calculated.

Once the batch size is determined (e.g., 10,000 lbs), the system is started and goes into batch make-up mode. An automated system calculates the available weight in the bins containing the major and micro component and determines if additional material is required before the requested batch can be made. If the quantity of any of the individual components are deficient, an alarm is communicated to the feed wagon operator for replenishing.

If all of the required components are available in sufficient quantity, the fill/no fill light changes from green to red, notifying the front-end loader operator that the feed boxes can no longer be filled. The common collection belt conveyor C-V-4 is started. After allowing the belt to come up to speed (e.g., about 30 seconds), each of the major components are loaded simultaneously onto the belt using the following protocol.

First, the sliding gate of the corn tank (SG-1) is opened to full open position until 90% of the dry-rolled corn mass has been added. After 90% of the dry-rolled corn mass has been added, SG-1 is then changed to a nearly closed position so as to trickle the final 10% of the corn into the batch mixer. Then, the Hay box discharge conveyor (CV-6) and the mixer for the Hay box is started. The discharge conveyor (CV-7) from the box containing either high moisture corn or wet distillers grains is started.

The SweetBran® box discharge conveyor (CV-5) and the mixer for the SweetBran® box is started. After 10% of the total SweetBran® weight has been added, the micro-ingredient addition system is started. The micro-ingredients are dosed over the next 75% of the total weight of SweetBran® using the mass addition rates determined above. The final 15% of the SweetBran® is loaded.

The equipment is shutdown in the opposite order in which it was started (e.g., mixers, discharge screws, common collection belt) and then the fill/no fill light is turned back to green. Using this process, an 8 ton batch is produced in about 3 mins, and a 10 ton batch is produced in about 3.75 mins.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of making an animal feed ration, comprising
providing a non-liquid admixture, wherein said non-liquid admixture comprises a non-liquid carrier and one or more low-inclusion ingredients; and
mixing said non-liquid admixture with a base animal feed, thereby producing an animal feed ration.

2. The method of claim 1, wherein said one or more low-inclusion ingredients are selected from the group consisting of ionophores, antibiotics, probiotics, vitamins, trace minerals, hormones, pheromones, nutraceuticals, pharmaceuticals, flavanoids, nutritive and non-nutritive supplements, and detoxicants.

3. The method of claim 1, wherein said non-liquid carrier is a high-moisture processed grain by-product.

4. The method of claim 1, wherein said non-liquid carrier is present in said animal feed ration at an amount of at least 15 weight percent.

5. The method of claim 1, wherein said non-liquid carrier is present in said animal feed ration at an amount between 15 and 85 weight percent.

6. The method of claim 3, wherein said non-liquid carrier is corn gluten feed.

7. The method of claim 1, wherein said base animal feed is ruminant feed, swine feed, poultry feed, equine feed, aquaculture feed, and wild game feed.

8. The method of claim 1, wherein said low-inclusion ingredients are formulated for lactating or gestating cows or growing and finishing shoats, steers or heifers.

9. The method of claim 1, wherein said method is carried out in the absence of a liquid carrier.

10. The method of claim 1, further comprising providing said animal feed ration to an animal.

11. A method for introducing one or more low-inclusion ingredients into an animal feed ration, comprising:
providing a non-liquid admixture, wherein said non-liquid admixture comprises a non-liquid carrier and said one or more low-inclusion ingredients; and
mixing said non-liquid admixture with a base animal feed to produce an animal feed ration, thereby introducing said one or more low-inclusion ingredients into said animal feed ration.

12. The method of claim 11, wherein said method maintains said low-inclusion ingredients in substantially uniform distribution in said feed ration.

13. A method of introducing and maintaining the substantial uniformity of low-inclusion ingredients in a feed ration, comprising:
providing a non-liquid admixture, wherein said non-liquid admixture comprises a non-liquid carrier and said one or more low-inclusion ingredients; and
mixing said non-liquid admixture with a base animal feed to produce an animal feed ration, thereby introducing and maintaining said substantial uniformity of said one or more low-inclusion ingredients in said animal feed ration.
